(19) United States
(12) Patent Application Publication
(10) Pub. No.: US 2014/0133862 A1
(43) Pub. Date: May 15, 2014

(54) RECEIVER OPTICAL MODULE INSTALLING OPTICAL DEMULTIPLEXER AND METHOD TO PRODUCE OPTICAL DEMULTIPLEXER

(71) Applicant: Sumitomo Electric Industries, Ltd., Osaka-shi (JP)

(72) Inventors: Yasushi Fujimura, Yokohama-shi (JP); Masanobu Kawamura, Yokohama-shi (JP)

(73) Assignee: Sumitomo Electric Industries, Ltd., Osaka-shi (JP)

(21) Appl. No.: 14/076,901

(22) Filed: Nov. 11, 2013

(30) Foreign Application Priority Data
Nov. 12, 2012 (JP) 2012-248013

(51) Int. Cl. H04J 14/02

(52) U.S. Cl. CPC H04J 14/02
USPC 398/79; 29/600

(57) ABSTRACT

A receiver optical module to receive a wavelength multiplexed light is disclosed. The optical module installs an optical demultiplexer to demultiplex the wavelength multiplexed light. The optical demultiplexer includes a wavelength selective filters each supported by a base substrate. A feature of the base substrate is that the base substrate in the plane shape thereof is a parallelogram with two sides forming an angle substantially equal to an incident angle of the wavelength multiplexed light input to the wavelength selective filter.

### BACKGROUND

1. Field

The present application relates to a receiver optical module that receives a wavelength multiplexed light and outputs a plurality of electrical signals.

2. Description of the Related Art

As an amount of information transmitted on the communication network increases, an optical transmitter/receiver module has been requested to be operable in the transmission speed exceeding 40 Gbps, sometimes reaching 100 Gbps. Such an optical module inevitably installs therein a plural active devices, typically a semiconductor laser diode (hereafter denoted as LD) and/or a semiconductor photodiode (hereafter denoted as PD) to perform the wavelength division multiplexing function.

In order to realize the transmission speed of 40 Gbps, a transmitter installs therein four sets of transmitter optical modules each operable in 10 Gbps and an optical multiplexer to multiplex optical signals coming from the respective transmitter modules; while a receiver installs an optical demultiplexer to demultiplex an optical signal containing four wavelengths into four independent optical signals depending on the wavelengths thereof and four sets of receiver optical subassemblies (ROSA) each receiving the demultiplexed optical signal.

In another aspect for an optical communication apparatus, an eager request to make the apparatus in compact has been continuously raised. As far as in a field of an optical transceiver, new standards of, for instance, CFP2, CFP4, QSFP+, and so on to make the outer dimensions of a housing in compact compared to the currently popular standard CFP have been proposed. In such a compact housing, spaces allocated to transmitter/receiver modules are further narrowed. For instance, the new standard defines the space for a receiver module with a width narrower than 7 mm. One practical solution for subjects above described is that a receiver module installs therein an optical demultiplexer type of the multilayered dielectric films. Japanese Patent Application Laid-Open publication Nos. JP-2009-198958A and JP-2011-209367A have disclosed such an optical demultiplexer.

### SUMMARY

An aspect of the present application relates to a receiver optical module that receives an input optical signal containing signals each having a specific wavelength different from others. The receiver optical module comprises an optical demultiplexer and a PD. The optical demultiplexer includes a body to receive the input optical signal and a base substrate providing a wavelength selective filter on one surface thereof. The wavelength selective filter, which is attached to the body, transmits only one of signals depending on the wavelength thereof. The PD receives one of signals selected by the wavelength selective filter. A feature of the optical demultiplexer is that the base substrate has a plane shape of a parallelogram with two sides opposite to each other extending substantially in parallel to an optical axis of one of signals transmitting in the base substrate.

The base substrate has a height greater than 0.3 mm, preferably greater than 1 mm, along the optical axis. Even in such an arrangement of the base substrate, one of the signals is output from a center of a surface of the base substrate.

The receiver optical module further includes an optical reflector, a support, and a package. The package, which has a box shape with a bottom, encloses the optical demultiplexer, the optical reflector, the support, and the PD therein. The PD is mounted on the bottom of the package, while, the optical demultiplexer and the optical reflector are mounted on the support in upside down. The optical reflector reflects signals output from the optical demultiplexer toward the PD in substantially right angle.

Another aspect of the present application relates to a method to produce an optical demultiplexer. The method includes steps of: (a) preparing a first base material for a body, second base materials for base substrates, and a third base material for a reflector, wherein the second base materials have a feature that they have a cross section of a parallelogram; (b) depositing wavelength selective filters on respective surfaces of the second base materials and a reflective film on a surface of the third base material; (c) attaching the third base material to one surface of the first base material such that the reflective film faces the first base material and attaching the second base materials to another surface of the first base material opposite to the one surface such that respective wavelength selective filters face the another surface and second base materials form no gaps therebetween; and (d) cutting the first base material with the second base materials and the third base material so as to obtain a plurality of wavelength demultiplexers each having an arrangement same with others.

### BRIEF DESCRIPTION OF THE DRAWINGS

The foregoing and other purposes, aspects and advantages will be better understood from the following detailed description of various embodiments with reference to the drawings, in which:

FIG. 1A is a perspective view showing an inside of a receiver optical module, and FIG. 1B is a plan view of an inside of the receiver optical module;

FIG. 2A functionally illustrates an optical demultiplexer and a reflector installed in the receiver optical module shown in FIG. 1A, and FIG. 2B magnifies a first portion of the optical demultiplexer shown in FIG. 2A;

FIGS. 3A to 3C show modifications of the optical demultiplexer shown in FIG. 2A;

FIGS. 4A to 4C show modifications of an installation of the optical demultiplexer and the reflector;

FIGS. 5A to 5D show a process to produce an optical demultiplexer; and

FIG. 6A is a plan view of an inside of a comparable optical module, and FIG. 6B magnifies a primary portion of the optical demultiplexer shown in FIG. 6B.

### DETAILED DESCRIPTION

Some embodiments will be described as referring to drawings.

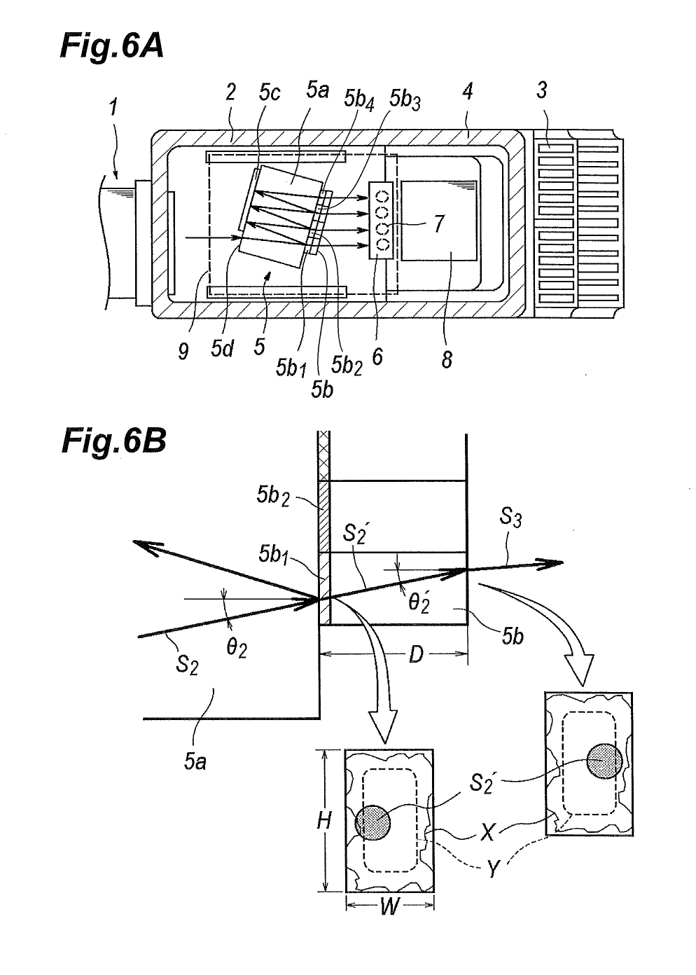

A comparable example is first explained as referring to FIGS. 6A and 6B. FIG. 6A schematically shows a plan view of a conventional receiver optical module, and FIG. 6B magnifies a primary portion to demultiplex an incoming optical signal into four independent demultiplexed signals. The comparable optical module primarily includes a coupling portion 1 to be optically coupled with an external fiber and a package 2. The package 2, which has a box shape, installs an optical demultiplexer 5, a reflector 6, a plural PDs 7, and a circuit 8 therein.

Referring to FIG. 6A, the optical demultiplexer 5 provides a body 5a with one side thereof providing a block 5b, where a plurality of wavelength selective filters, 5b₁ to 5b₄, made of multilayered dielectric films each transmitting one optical signal with a specific wavelength different from others, while reflecting rest of optical signals, are attached such that the multi-layered dielectric films are put between the body 5a and the block 5b. Another side 5d opposite to the side described above provides a reflecting film 5c to reflect light coming from the filters, 5b₁ to 5b₃, toward the next filters, 5b₂ to 5b₄. The optical demultiplexer 5 is mounted on a support 9 denoted by a broken line in FIG. 6A, in an arrangement of upside down.

An optical signal that multiplexes, for instance, four signals having wavelengths, λ₁ to λ₄, which is coming from the coupling portion 1, enters one side 5d of the body 5a by a preset angle; where the portion of the side 5d removes the reflecting film 5c. The incoming optical signal is refracted at the side or interface 5d of the body 5a and enters the first filter 5b₁ by an angle of θ₂. The first filter 5b₁ transmits one optical signal with the wavelength λ₁ but reflects rest of optical signals including wavelengths λ₂ to λ₄ toward the reflecting film 5c. The second filter 5b₂ transmits another one optical signal with the wavelength λ₂ but reflects rest of optical signals containing wavelengths λ₃ and λ₄.

Iterating the process thus described, the third filter 5b₃ transmits one optical signal with a wavelength of λ₃ and the fourth filter 5b₄ transmits one optical signal with a wavelength of λ₄. The demultiplexed optical signals are reflected by the reflector 6, focused by concentrating lenses not explicitly shown in figures, and finally enter respective PDs 7.

The filters, 5b₁ to 5b₄, described above are necessary to have a steep cut-off performance to distinguish the transmittable wavelength securely. In order to obtain such performance, a filter inevitably has a number of dielectric films, sometimes exceeding a hundred layers with a total thickness of several tens micron meters. A conventional process to form such a filter is to deposit dielectric films on a base substrate with a thickness of 5 to 10 mm, to thin the base substrate to a designed thickness by, for instance, polishing and/or grinding, and to attach the thinned substrate with the dielectric films to the body 5a. However, when the thinned substrate has a thickness of 0.3 mm or less, this thinned substrate easily bends due to the stress caused by the multilayered dielectric films.

A thicker base substrate, for instance thicker than 0.3 mm, would suppress the bend thereof. However, as shown in FIG. 6B, considering planar dimensions of the base substrates for respective filters, 5b₁ to 5b₄, which are typically 500 μm in a width W and 800 μm in height H formed by dicing or cutting from a wider substrate; an effective area Y for transmitting/reflecting light is restricted to an inner portion narrower than the planar dimensions above described because the dicing or cutting causes chipping and/or breaking of peripheral portions X of the base substrate.

The optical beam S₂ coming from the body 5a enters the filter 5b₁ by the angle of θ₂ and becomes another optical beam S₂′ by transmitting through the filter 5b₁ as keeping this incident angle θ₂ when the base substrate 5b has the refractive index thereof substantially same as that of the body 5a. When the base substrate 5b is assembled with the body 5a normally as shown in FIG. 6B, the position where the optical beam S₂′ is output from the base substrate 5b is offset from the position where the optical beam S₂ enters in the filter 5b1 as the base substrate becomes thicker, which occasionally forces the optical beams, S₂ and S₂′, to pass outside of the effective area Y. Reducing the incident angle θ₂, the offset between the input and output positions becomes smaller; however, this arrangement needs a larger optical demultiplexer along the optical beam S₂ to secure a distance between outgoing beams S₃.

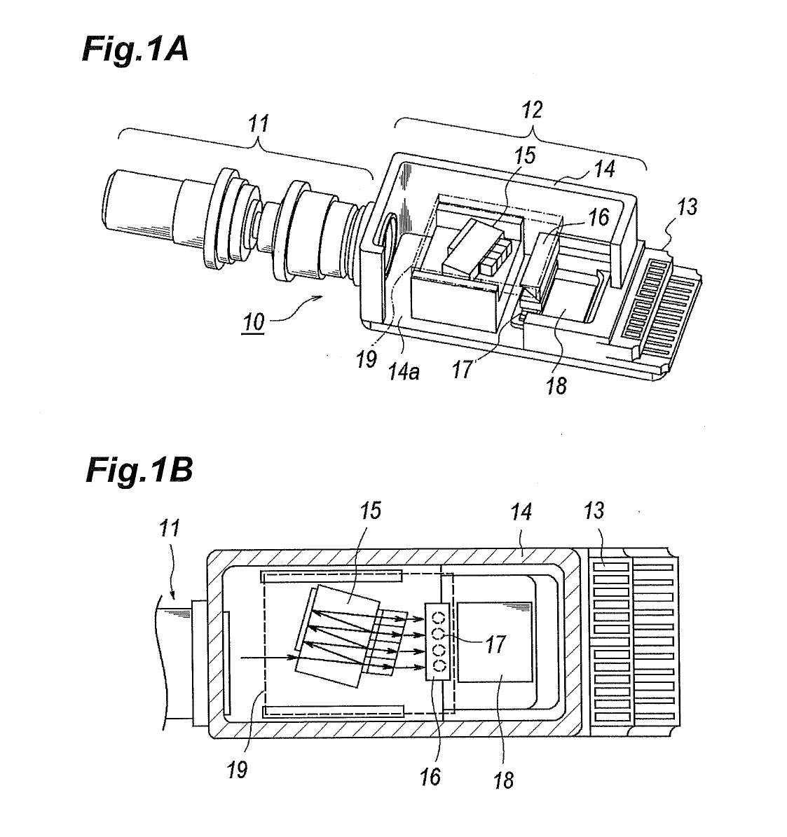

Next, some embodiments will be described as referring to drawings. FIG. 1A is a perspective view of a receiver optical module 10, where FIG. 1A removes some elements to show an inside of the optical module; and FIG. 1B is a plan view thereof. The receiver optical module 10 primarily comprises an optical coupling portion 11 and a housing 12. The optical coupling portion 11 is assembled with one side of the housing 12, which will be called as a front side. The housing 12 includes an electrical plug 13 in a rear side thereof. The present specification defines the sides of the front and the rear only for the explanation sake. The housing 12 encloses an optical demultiplexer 15, a reflector 16, a plurality of PDs 17, an integrated circuit (IC) 18 and a support 19 within a space formed by a box shaped package 14.

The package 14 is made of metal in the present embodiment, while, the electrical plug 13 is made of multi-layered ceramics having a plurality of electrodes thereon. The coupling portion 11, which comprises of some optical elements, such as a sleeve, a stub, a concentrating lens, and so on, optically couples the PDs 17 with an external fiber set in the optical coupling portion 11.

The optical demultiplexer and the reflector 16 are mounted on a support 19 in upside down such that the reflecting surface of the reflector 16 faces the PDs 17 mounted on the bottom 14a of the package 14. The optical demultiplexer demultiplexes an input optical signal output from the optical coupling portion 11 into several optical beams depending on wavelengths contained in the input optical signal. The demultiplexed optical signals are reflected by the reflector 16 toward the PDs 17. The IC 18, which is set aside the PDs 17, includes pre-amplifiers to amplify electrical signals generated by the PDs 17 and outputs thus amplified electrical signals to the outside of the module 10 through the electrical plug 13.

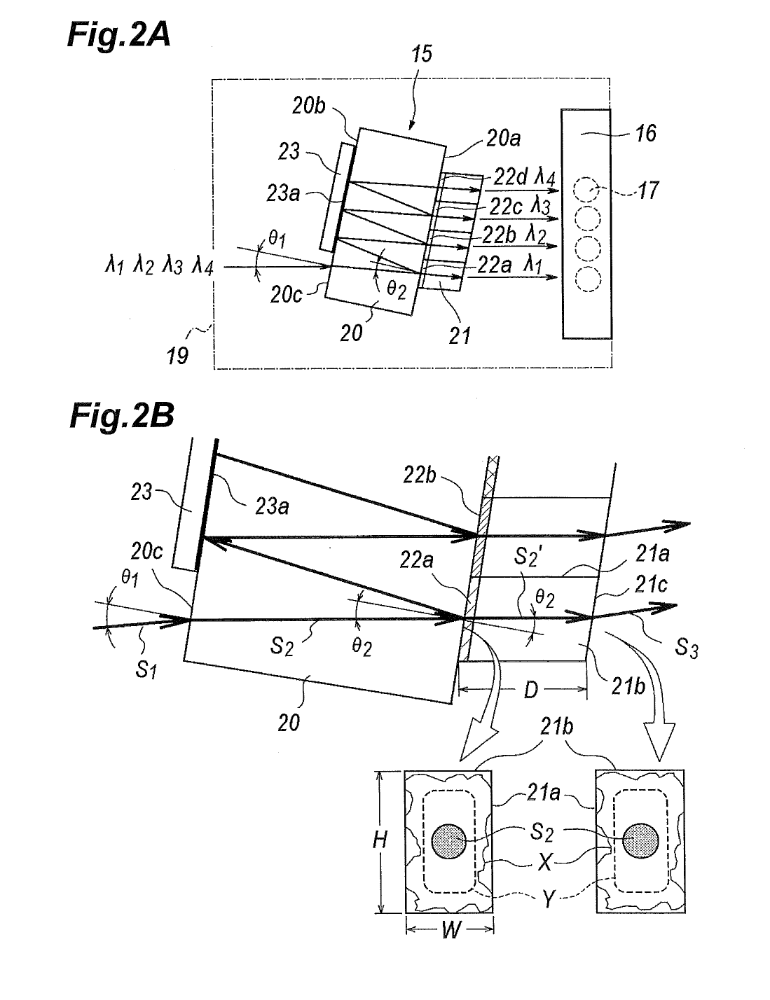

FIG. 2A describes the function of the optical demultiplexer 15, and FIG. 2B magnifies a portion around the first filter 22a. The optical demultiplexer 15 comprises a body 20, which is typically made of glass, with a rectangular planar shape, a plurality of wavelength selective filters, 22a to 22d, made of multilayered dielectric films attached to one side 20a of the body 20, and an optical reflector 23 attached to the other side 20b of the body 20. The optical reflector 23 provides a reflecting film 23a on the surface thereof facing and being attached to the body 20. The other side 20b also provides an area or incident surface 20c exposing the body 20 through which the input optical signal coming from the optical coupling portion 11 and multiplexing wavelengths, λ₁ to λ₄, enters. The wavelength selective filters, 22a to 22d, each transmits one optical signal with a specific wavelength different from others and reflects rest of optical signals toward the reflector 23. In the present embodiment, the wavelengths, λ₁ to λ₄, are assumed to be 1331, 1311, 1291, and 1271 nm, respectively, which follows the standard of, what is called, the coarse wavelength division multiplexing (CWDM) system.

The optical beam S₁ enters the area 20c in the side 20b by an incident angle θ₁, which is about 15° in the present embodiment. The optical beam S₁ is refracted at the interface or incident surface 20c of the body to the angle of θ₂ by the Fresnel refraction, which is about 10° corresponding to the incident angle above, and enters the first wavelength selective filter 22a by this angle θ₂. The first filter 22a transmits only an optical signal having the wavelength λ₁, and reflects rest of optical signals with the wavelengths, λ₂ to λ₄, toward the reflector 23. The optical beam S₂ passing the first filter 22a is refracted at an output surface or interface 21c against the atmosphere and output as the optical beam S₃ containing the wavelength λ₁ toward the reflector 16 and the PD 17.

The second to fourth filters, 22b to 22d, operate in the same manner with the first filter 22a but the wavelengths to be transmitted are the second to fourth wavelengths λ₂ to λ₄, respectively. Thus, the optical demultiplexer 15 demultiplexes the optical beam S₁ into optical beams S₃ depending on the wavelengths contained therein.

FIG. 2B magnifies a portion around the first filter 22a of the present embodiment. The optical beam S₁ entering the body 20 with the incident angle θ₁ enters the first filter 22a in a center portion thereof with the incident angle θ₂. A portion of the optical beam S₂ transmits the first filter 22a and enters the base substrate 21 as the optical beams S₂′ with the angle θ₂, which assumes that the base substrate 21 is made of material whose refractive index is substantially same as that of the body 20. In the present embodiment, the body 20 and the base substrate 21 are both made of glass. Accordingly, the outgoing angle of the beam S₂′ from the first filer 22a is substantially equal to the incident angle to the first filter 22a, where both angles are denoted as θ₂. The optical beam S₂′ passing the base substrate 21 is output from the output surface 21c as the optical beam S₃ that contains only one wavelength λ₁.

The base substrate 21 has a plane shape of a parallelogram with dimensions of a thickness D along the axis of the optical beam S₂40 propagating therein, a width W about 500 μm, and a height H about 800 μm. Two sides 21a and other two sides 21b, which are in parallel to the optical beam S₂, are formed by cutting a larger sized substrate. As already described, the cutting and/or dicing causes chipping and breaking in peripheral areas X; accordingly, effective areas Y provided in the input surface of the base substrate 21 and the output surface 21c are restricted so as to escape from these chipping and breaking.

The embodiment shown in figures has a feature that the base substrate 21 to support filters, 22a to 22d, has a thickness D along the optical beam S₂ to be 0.3 mm or greater; and the input surface and the output surface 21c through which the optical beam S₂′ passes are inclined with respect to the optical beam S₂ by an angle substantially equal to the incident angle θ₂. A thicker base substrate 21 securely supports the filter, 22a to 22d; that is, the bend of the wavelength filter, 22a to 22d, due to the stress caused by the filter stacking the number of dielectric films is compensated.

On the other hand, a thicker base substrate with the rectangular plane shape causes the offset between positions through which the optical beams S₂ passes and the positions sometimes are forced to be out of the effective area Y. In the base substrate 21 of the embodiment, the optical beam S₂ passes in substantially a center of the input surface and the output surface 21c because the input surface and the output surface 21c make an angle against the sides 21a substantially equal to the incident angle θ₂ of the optical beam S₂.

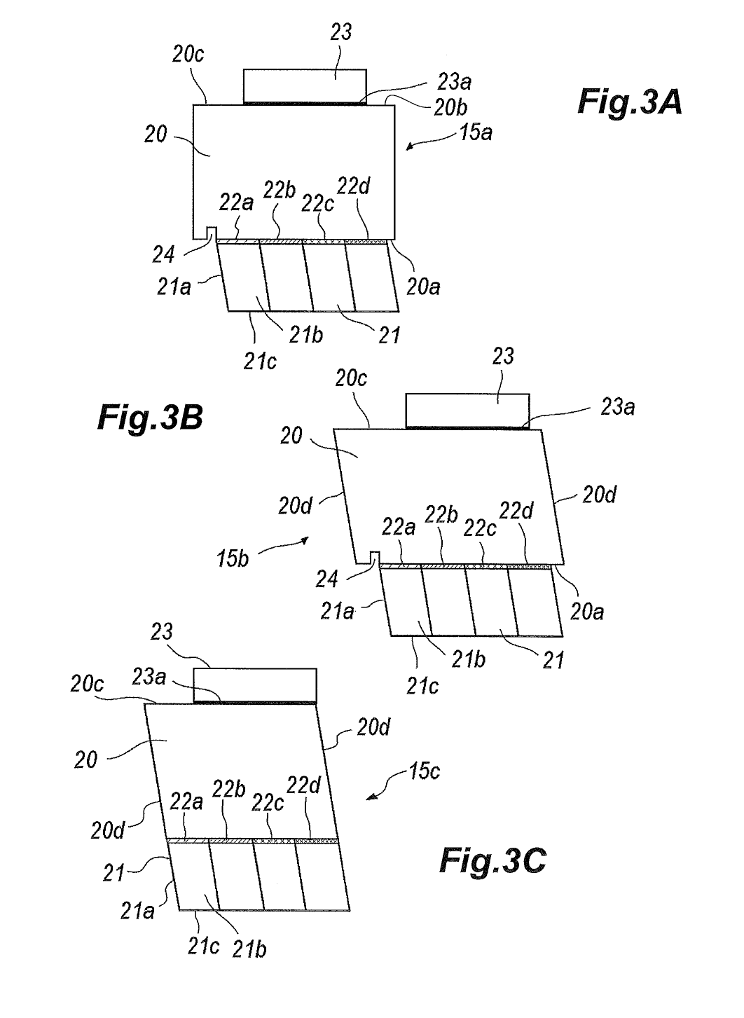

FIGS. 3A to 3C show various modifications of the base substrate 21. The optical demultiplexer 15a shown in FIG. 3A provides a groove 24 in the surface 20a of the body 20 for define the position of base substrate 21 against the body 20.

The base substrate 21, which attaches the dielectric films for the wavelength selective filters, 22a to 22d, to the input surface thereof, are arranged such that the first base substrate 21 is set along the groove 24, while, subsequent base substrates 21 are set to make one side 21a thereof in contact with the neighbor base substrate 21 without causing any gap therebetween and to align top and bottom sides 21b with the former base substrate 21. The reflector 23 is formed such that a reflective film 23a is directly deposited on the side 20b or the reflector 23 with the reflective film 23a is attached to the side 20b.

An optical demultiplexer 15b shown in FIG. 3B provides the body 20 with the sides 20d substantially in parallel to the side 21a of the base substrate 21. That is, the sides 20d is inclined with the incident surface 20c and the outgoing surface 20a by the angle substantially equal to the incident angle θ₂ of the optical beam S₂, as already described. That is, the sides 20d are substantially in parallel to the optical beam S₂. This arrangement of the body 20 makes the optical demultiplexer 15b in compact.

The optical demultiplexer 15c shown in FIG. 3C also has the side 20d in the body 20 thereof substantially in parallel to the optical beam S₂. A feature of the arrangement of the body 20 of the optical demultiplexer 15c is that the width of the body is further shrank to the total width of the base substrate 21, that is, a width when the base substrates 21 are arranged in an array. The alignment groove 24 is unnecessary in this modified optical demultiplexer.

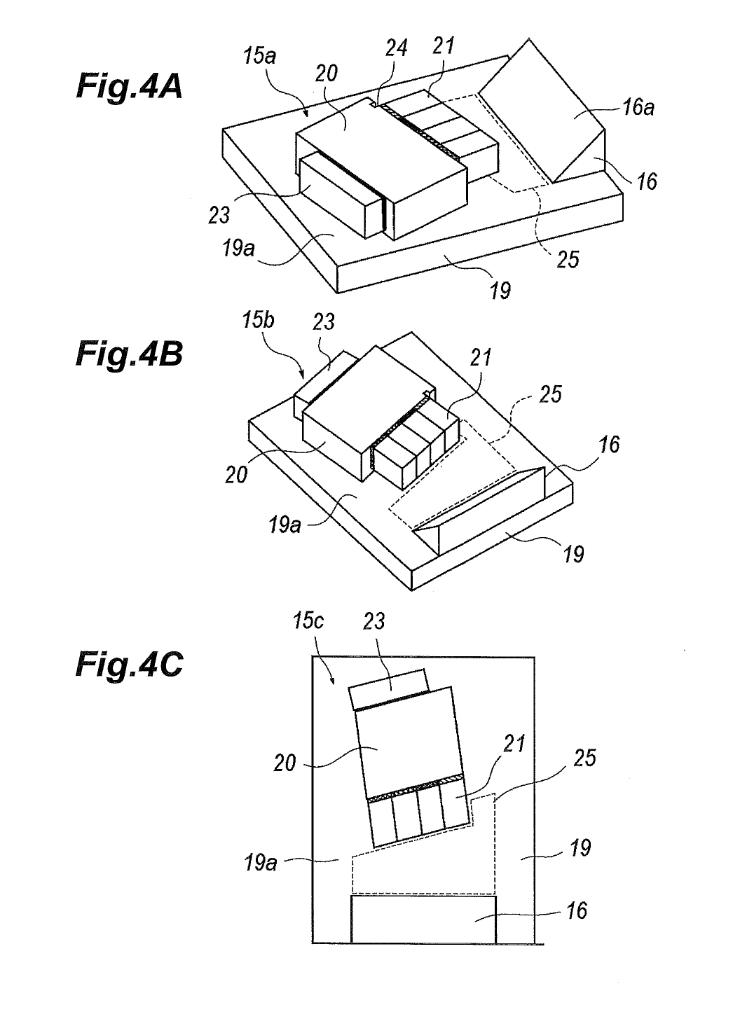

FIGS. 4A to 4C are perspective views showing assemblies including the optical demultiplexer, 15a to 15c, shown in FIGS. 3A to 3C and the optical reflector 16 set on the support 18, respectively.

The support 19, which is made of ceramic such as alumina (Al₂O₃), has a surface 19a on which the optical demultiplexer, 15 to 15c, and the reflector 16 are mounted. The reflector 16 is a type of prism with an oblique surface 16a as the reflecting surface. The surface 19a further provides a marker 25 to align the optical demultiplexer, 15 to 15c, and the reflector 16. The support 19 thus mounting the optical elements, 15 to 15c and 16, is assembled within the housing 12 as the surface 19a facing the bottom 14a of the package 14.

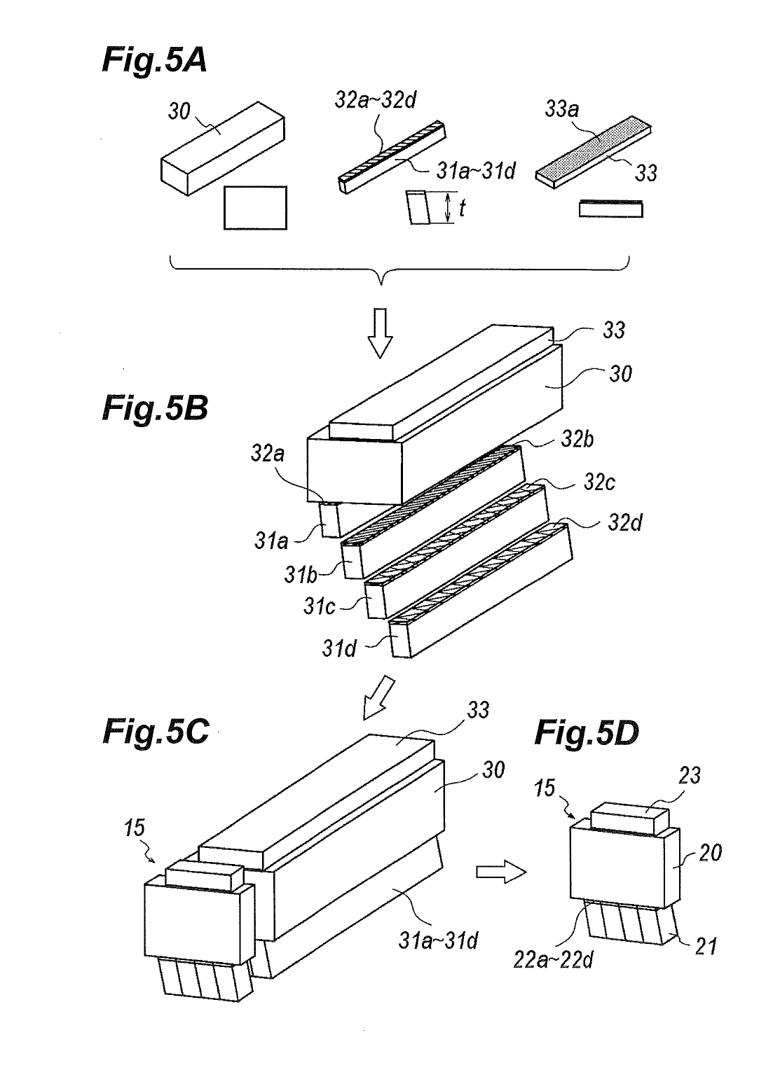

FIGS. 5A to 5D show a process to form the optical demultiplexer, 15 to 15c. First, a base material 30 to form the body 20 is prepared. The base material 30 is typically made of glass and has a rectangular cross section in the present example. Concurrently, a set of base materials for base substrates, 31a to 31d, are prepared, where each of the base materials, 31a to 31d, is made of also glass and provides one of wavelength selective filters, 32a to 32d, on a side thereof. Respective base materials, 31a to 31d, in the cross section thereof has a parallelogram with a thickness t greater than 0.3 mm, preferably greater than 1 mm. The angle of two sides of the parallelogram depends on the refractive index of the base materials, 31a to 31d, and two sides extend substantially in parallel to the optical axis of the optical beam S₂ passing the substrate, 31a to 31d. Moreover, the base material 33 with the reflecting film 33a thereon for the reflector 23 is also prepared.

Next, the base materials, 31a to 31d, for the filters are attached to one surface of the base material 30 such that the filters, 32a to 32d, prepared on the surface of the base materials, 31a to 31d, are in contact with the one surface, and respective materials, 31a to 31d, are in contact with the next base materials without forming a gap therebetween. The base material for the reflector block 33 is attached to the other surface of the base material 30 opposite to the one surface where the base materials, 31a to 31d, are attached. Thus, an intermediate assembly of the base material 30 attached with the material 33 for the reflector 23 and the materials, 31a to 31d, is prepared.

Then, the process divides the thus formed intermediate assembly into a plurality of optical demultiplexers each having a designed thickness as shown in FIG. 5C. In the process described above, the base material 30 has a rectangular shape; accordingly, the optical demultiplexer formed from the base material 30 is the type of those shown FIGS. 1A and 2A; that is, the body 20 has a shape of a rectangular block having right angled corners. When the base material 30 provides the groove 24 shown in FIG. 3A, the optical demultiplexer 15a type of those shown in FIG. 3A is formed. Also, when the base material 30 in the cross section thereof is parallelogram and has a groove; then, optical demultiplexer type of that shown in FIG. 3B is obtained. Lastly, equalizing the width of the parallelogram base material 30 to the total width of the base materials, 31a to 31d, for the filters, where they are placed in the array without any gap, the optical demultiplexer 15c type of that shown in FIG. 5C is obtained.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A receiver optical module configured to receive an input optical signal that contains signals each having a specific wavelength different from others, comprising:
an optical demultiplexer including a body configured to receive the input optical signal and a base substrate providing on one surface thereof a wavelength selective filter put between the body and the base substrate, the wavelength selective filter transmitting one of signals depending on the wavelength thereof, the base substrate having a plane shape of a parallelogram with two sides opposite to each other extending substantially in parallel to an optical axis of one of the signals transmitting in the base substrate; and
a photodiode (PD) configured to receive one of the signals output from the base substrate.

2. The receiver optical module of claim 1,
wherein the input optical signal passing the body enters the wavelength selective filter with an incident angle and one of signals is output from the wavelength selective filter to the base substrate with an outgoing angle substantially equal to the incident angle.

3. The receiver optical module of claim 2,
wherein the body and the base substrate are made of glass and the wavelength selective filter is made of multilayered dielectric films.

4. The receiver optical module of claim 1,
wherein the input optical signal passing the body enters the wavelength selective filter in substantially a center portion thereof, and one of the signals transmitting through the base substrate is output from a surface of the base substrate opposite to the wavelength filter in substantially a center thereof

5. The receiver optical module of claim 1
wherein the base substrate has a thickness greater than 0.3 mm along the optical axis of one of the signals passing the base substrate.

6. The receiver optical module of claim 5,
wherein the base substrate has the thickness greater than 1 mm.

7. The receiver optical module of claim 1,
wherein the base substrate is attached to the body along a groove provided in a surface of the body.

8. A receiver optical module, comprising:
an optical demultiplexer configured to demultiplex an input optical signal into signals each having a specific wavelength different from others;
an optical reflector configured to reflect respective signals output from the optical demultiplexer substantially in a right angle;
a plurality of photodiodes (PDs) configured to receive the signals output from the optical demultiplexer and reflected by the optical reflector;
a support configured to mount the optical demultiplexer and the optical reflector on a surface facing the PDs,
wherein the optical demultiplexer includes a body configured to receive the input optical signal at an incident surface thereof, and a plurality of base substrates each providing a wavelength selective filter configured to transmit one of the signals depending on the wavelengths, each of the base substrates having a plane shape of a parallelogram with sides extending substantially in parallel to optical axes of the signals transmitting in the base substrates.

9. The receiver optical module of claim 8,
wherein the body and the base substrates are made of glass.

10. The receiver optical module of claim 8,
wherein the wavelength selective filters are made of multilayered dielectric films.

11. The receiver optical module of claim 8,
wherein the base substrates have a thickness greater than 0.3 mm along the optical axes of the signals transmitting in the base substrates.

12. The receiver optical module of claim 11,
wherein the base substrates have the thickness greater than 1 mm.

13. The receiver optical module of claim 8,
further including a box shaped package enclosing the optical demultiplexer, the reflector, the PDs and the support therein,
wherein the PDs are mounted on a bottom of the package, and the optical demultiplexer and the reflector are mounted on the surface of the support facing the bottom of the package in upside down.

14. The receiver optical module of claim 8,
further including an integrated circuit (IC) set aside the PDs and an electrical plug, the IC including pre-amplifiers to amplify electrical signals generated by respective PDs and output amplified signals to an outside of the package through the electrical plug.

15. A method to produce an optical demultiplexer, comprising steps of:
preparing a first base material for a body, second base materials for base substrates, and a third base material for a reflector, wherein the second base materials each has a cross section of a parallelogram;
depositing wavelength selective filters on respective surfaces of the second base materials and a reflective film on a surface of the third base material, wherein the wavelength selective filters each has a specific transmission spectrum different from transmission spectra of other wavelength selective filters;
attaching the third base material with the reflective film to one surface of the first base material such that the reflective film attaches to the first base material;
attaching the second base materials to another surface of the first base material opposite to the one surface such that respective wavelength selective filters face the another surface as forming no gaps between the second base materials; and
cutting the first base material with the second base materials and the third base material so as to obtain a plurality of wavelength demultiplexers each having an arrangement same with others.

16. The method of claim 15,
wherein the first base material has a cross section of a parallelogram with sides opposite to each other extending substantially in parallel to two sides opposite to each other of each of the second base materials.

17. The method of claim 15,
wherein the first base material has a groove in the another surface, and
wherein the step of attaching the second base materials to the another surface of the first base material includes a step in which one of the second base materials firstly attached to the first base material is aligned with the groove.
